(19) United States
(12) Patent Application Publication
(10) Pub. No.: US 2019/0381786 A1
(43) Pub. Date: Dec. 19, 2019

(54) GLASS HAVING PRINTED LAYER ON CURVED SURFACE THEREOF AND PRINTING METHOD THEREOF

(71) Applicant: AGC Inc., Chiyoda-ku (JP)

(72) Inventor: Hidenobu WATANABE, Tokyo (JP)

(73) Assignee: AGC Inc., Chiyoda-ku (JP)

(21) Appl. No.: 16/440,294

(22) Filed: Jun. 13, 2019

(30) Foreign Application Priority Data
Jun. 13, 2018 (JP) 2018-113014

(51) Int. Cl. B41F 17/00; B41M 1/34

(52) U.S. Cl. CPC B41F 17/006; B41M 5/0047; B41M 1/34

(57) ABSTRACT

The present invention relates to a method of forming a printed layer on a glass including a curved surface area, the method including: a printing step of printing with a thermally-curable first ink on the curved surface area to form a first printed layer; and a drying step of drying the first printed layer.

### TECHNICAL FIELD

The present invention relates to a glass having a printed layer on a curved surface thereof and a printing method thereof

### BACKGROUND ART

As the amount of information increases, the need of high performance display is increasing. Accordingly, many cover glasses having a flat main surface are developed for mobile phones, mobile tablets, in-vehicle displays and the like. On the other hand, the demand of a cover glass for a display having a curved surface also increases. However, such a cover glass having a curved surface has difficulty in molding and strengthening as compared with a flat glass, and further has the problem that appearance quality is insufficient due to uneven color after forming a printed layer.

Even in a cover glass having a printed layer on a curved surface thereof, a cover glass having excellent appearance quality is required to be provided by controlling a film thickness of the printed layer to a range in which uneven color does not occur over the entire cover glass.
Patent Literature 1: JP-A-2009-234056

### SUMMARY OF INVENTION

The present inventors have found that when a plurality of printed layers are formed on a glass having a curved surface, because a thickness of an ink printed on the curved surface changes along an inclination of the curved surface, interference of light is generated between a reflected light at an interface between the glass and a first printed layer and a reflected light at an interface between the first printed layer and a second printed layer. As a result, uneven color occurs.

Patent Literature 1 discloses a printing method simultaneously using an ink-peelable glass sheet and a glass letterpress, in which at least one of those uses a bendable thin sheet-like glass. According to the printing method of Patent Literature 1, an ink remained on the ink-peelable glass sheet is pre-dried to make a semidried state and removal of a pattern and transfer to a base material to be transferred are possible without conducting a heat treatment. However, the pre-drying step does not suppose that when an ink is applied to a glass having a curved surface and is dried, a thickness of the ink changes along an inclination of the curved surface.

When preparing a glass having excellent weathering resistance, since a thermally-curable ink which is difficult to react with light is used, a certain period of time is required until the ink cures. To overcome this problem, a drying step is newly added to the ink. As a result, the thickness of the ink at an end part of a singly curved or multiply curved glass after printing with the ink can be maintained constant, and a glass having excellent appearance quality can be provided.

A printed layer is sometimes formed on a cover glass attached to an outer surface. In this case, the printed layer is required to have weathering resistance. Therefore, the printing is preferably conducted using a thermally-curable ink, not a photosetting ink from the standpoint of weathering resistance. However, when a thermally-curable ink is used, the ink cannot be promptly cured with ultraviolet lays or the like after printing, which is different from the case of using a photosetting ink. The thickness of the ink printed on a cover glass having a curved surface changes along an inclination of the curved surface. Therefore, the ink tends to be thinly printed on the curved surface as compared with a flat area.

When a plurality of printed layers are formed on a cover glass, a reflection position of incident light entering a glass changes in a curved surface part on which an ink is thinly printed as compared with a flat part on which an ink is printed in the intended thickness. In other words, the reflected light at the interface between the cover glass and the first printed layer interferes with the reflected light at the interface between the first printed layer and the second printed layer, which causes uneven color and leads to deterioration of appearance quality.

The present inventors have completed the present invention by conducting a printing step of printing with a thermally-curable ink on a curved surface of a glass to form a printed area, and a drying step of drying the printed area to form a first printed layer.

Specifically, the present invention is as follows.

1. A method of forming a printed layer on a glass including a curved surface area, the method including:
a printing step of printing with a thermally-curable first ink on the curved surface area to form a first printed layer; and
a drying step of drying the first printed layer.
   2. The method of forming a printed layer described in 1 above, further including a curing step of thermally curing the first printed layer after the drying step.
   3. The method of forming a printed layer described in 1 or 2 above, further including a printing step of printing with a second ink on the first printed layer to form a second printed layer.
   4. The method of forming a printed layer described in 3 above, in which the first printed layer is an infrared transmitting layer, and the second printed layer is a light shielding layer.
   5. The method of forming a printed layer described in 3 above, in which the second ink is a thermally-curable ink.
   6. The method of forming a printed layer described in any one of 1 to 3 above, in which the first ink is an ink having a light transmitting property.
   7. The method of forming a printed layer described in any one of 1 to 3 above, in which the first ink is an ink having an infrared transmitting property.
   8. The method of forming a printed layer described in 3 above, in which the second ink is an ink having a light shielding property.
   9. The method of forming a printed layer described in any one of 1 to 8 above, in which the drying step is conducted by a lamp heater.
   10. The method of forming a printed layer described in any one of 2 to 9 above, in which the curing step is conducted in a drying furnace.
   11. The method of forming a printed layer described in any one of 1 to 10 above, in which the glass is a cover glass.
   12. A glass including a curved surface area that includes a printed layer formed thereon with a thermally-curable first ink, in which:
the printed layer is formed on the curved surface area;
the printed layer includes a first printed layer and a second printed layer;
the first printed layer and the second printed layer have different visible light transmittances from each other;
the first printed layer has the visible light transmittance higher than the visible light transmittance of the second printed layer; and
the first printed layer has a film thickness being constant in the curved surface area or being in a range in which an uneven color does not occur in the curved surface area.
   13. The glass described in 12 above, in which the first printed layer is an infrared transmitting layer, and the second printed layer is a light shielding layer.
   14. The glass described in 12 above, in which the first printed layer has the visible light transmittance of 1% or less.
   15. The glass described in 12 above, in which the second printed layer has the visible light transmittance of 0.01% or less.
   16. The glass described in 12 above, in which the glass is a chemically strengthened glass.
   17. The glass described in 12 above, in which the glass is a multiply curved glass.
   18. The glass described in 12 above, in which the glass is a cover glass.

According to the method of forming a printed layer of the present invention, a glass free of uneven color having excellent appearance quality can be manufactured even though the glass has a curved surface.

### BRIEF DESCRIPTION OF DRAWINGS

FIG. 1A is a perspective view of a cover glass having a curved surface area in a visual recognition area.

FIG. 1B is a perspective view of a cover glass having a flat visual recognition area.

FIG. 2A is a flow chart showing a conventional printed layer forming step.

FIG. 2B is a flow chart showing the printed layer forming step according to one embodiment of the present invention.

FIG. 3A is a front view of a conventional cover glass having a curved surface area.

FIG. 3B is an enlarged view of the front view of the conventional cover glass.

FIG. 4A is a front view according to one embodiment of the cover glass of the present invention having a curved surface area.

FIG. 4B is an enlarged view of the front view according to the one embodiment of the cover glass of the present invention.

FIG. 5 is a view for explaining a thickness of a glass sheet-shaped body forming a cover glass.

FIG. 6 is a perspective view according to one embodiment of a cover glass of the present invention having a plurality of curved surface areas.

FIG. 7 is a plan view of a cover glass having a printed layer formed on a flat area.

### DESCRIPTION OF EMBODIMENTS

The definition of the following terms is applied over the present description.

The term “flat area” means the part having an average curvature radius of more than 10000 mm.

The term “curved surface area” means the part having an average curvature radius of 10000 mm or less.

(Cover Glass)

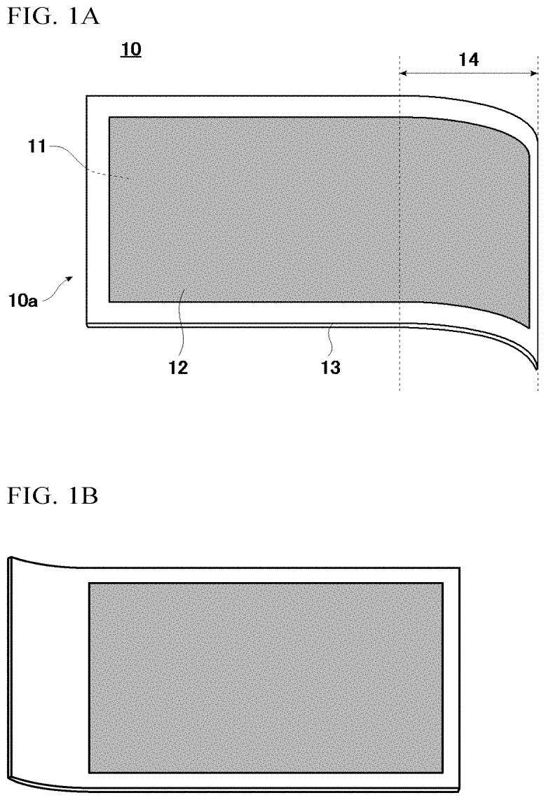

One embodiment of the present invention is described below by showing the cover glass as an example thereof, with reference to FIG. 1A and FIG. 1B. However, the glass of the present invention is not limited to the embodiment below.

FIG. 1A is a view for explaining a cover glass 10 of the present embodiment. As shown in FIG. 1A, the cover glass 10 of this embodiment includes a glass sheet-shaped body 10a having a first surface 11, a second surface 12 facing the first surface 11 and at least one end face 13 connecting the first surface 11 and the second surface 12. The cover glass 10 has a printed layer, and the glass sheet-shaped body 10a in the present description means a sheet-shaped body in which lengths in a longitudinal direction or a short direction of the first surface 11 and the second surface 12 are larger than a thickness of the end face 13. Furthermore, the cover glass 10 of this embodiment has a curved surface area and therefore does not mean a flat sheet-shaped sheet glass.

Of two main surfaces of the glass sheet-shaped body 10a, it is not particularly limited as to whether any one main surface is the first surface or the second surface. However, when the glass sheet-shaped body is used as a cover glass of interior parts for automobile, a display device and the like, the surface exposing outside, i.e., the surface at the side of a display surface, is determined as the first surface of the glass sheet-shaped body 10a. Therefore, the surface facing a display surface of interior parts for automobile, a display device and the like is the second surface of the glass sheet-shaped body 10a. In this embodiment, an infrared transmitting layer and a black layer are formed as printed layers on the second surface of the cover glass 10, the infrared transmitting layer functions as a layer transmitting infrared rays and the black layer functions as a layer shielding light. In FIG. 1A, a visual recognition area of a display forms a curved surface area 14, but the visual recognition area of the display may be formed on only a flat area as shown in FIG. 1B. In FIGS. 1A and 1B, the visual recognition area of the display is shown by gray tone. In the present invention, the printed layer is not limited to the infrared transmitting layer and the black layer (light shielding layer). In case where a plurality of printed layers are formed on a curved surface of a glass, when the first printed layer is replaced by the infrared transmitting layer and the second printed layer is replaced by the black layer (light shielding layer), such a glass can be applied to various uses. A first ink used in the first printed layer is a thermally curable ink. The first ink may be an ink having a light transmitting property. A second ink used in the second printed layer may be a thermally curable ink. The second ink may be an ink having a light shielding property. The light shielding layer is a film having a light shielding property. It is preferable that light shielding region has a visible light transmittance of 0.1% or less measured in accordance with JIS R3106. It is preferable that infrared transmitting region has a visible light transmittance of 5% or less measured in accordance with JIS R3106, and has a transmittance of 60% or more with respect to an infrared ray having a wavelength of 850 nm to 1000 nm. Furthermore, it is preferable that infrared transmitting region has a transmittance of 70% or more with respect to an infrared ray having a wavelength of 900 nm to 1000 nm.

Another embodiment of the present invention is a glass including a curved surface area that includes a printed layer formed thereon with a thermally-curable first ink, in which: the printed layer is formed on the curved surface area; the printed layer includes a first printed layer and a second printed layer; the first printed layer and the second printed layer have different visible light transmittances from each other; the first printed layer has the visible light transmittance higher than the visible light transmittance of the second printed layer; and the first printed layer has a film thickness being constant in the curved surface area or being in a range in which an uneven color does not occur in the curved surface area. The glass may be a cover glass. The visible light transmittance of the first printed layer may be 1% or less, and the visible light transmittance of the second printed layer may be 0.01% or less. A glass having the above features has an advantages that uneven color does not occur and appearance quality is improved. The visible light transmittance is a value measured at room temperature by using illuminant D65 of CIE (Commission Internationale de I'Eclairage) standard as a light source, in accordance with JIS R3106. The illuminant D65 is specified in JIS Z8720 (2012).

Antiglare treatment (AG treatment), antireflection treatment (AR treatment), anti-fingerprint treatment (AFP treatment) or the like is preferably applied to at least one of the first surface 11 and the second surface 12 of the cover glass 10. Primer treatment, etching treatment or the like may be applied to the surface and a chamfered part, on which the printed layer is to be provided, in order to improve adhesion to the printed layer.

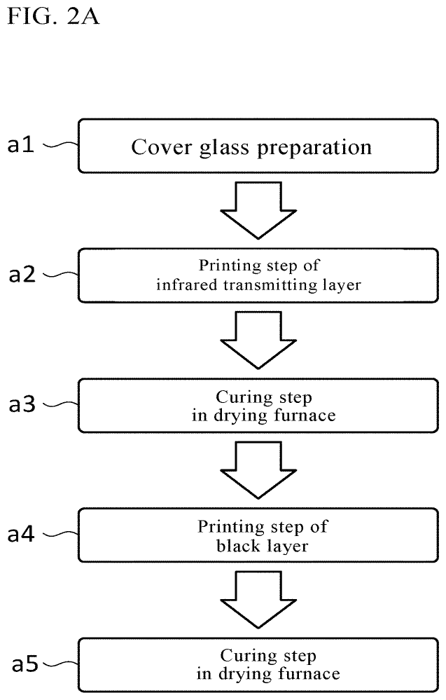

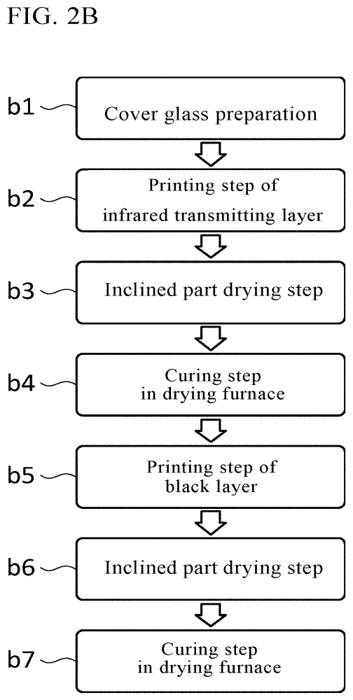

FIG. 2A (a1 to a5) is a flow chart showing the conventional printing method of a printed layer. In FIG. 2A, a step of drying an inclined part after printing the infrared transmitting layer or after printing the black layer is not provided.

FIG. 2B (b1 to b7) is a flow chart showing the printing method of the printed layer according to this embodiment. In this embodiment, an inclined part drying step is provided between the printing step of the infrared transmitting layer and the curing step in a drying furnace, and between the printing step of the black layer and the curing step in a drying furnace. The “inclined part drying” means a step of drying the curved surface area of the cover glass 10 in this embodiment. When the inclined part drying step is added to the conventional flow chart (FIG. 2A), the ink printed on the curved surface area is fixed and the thickness of the ink can be prevented from changing along the inclination. The temperature necessary in the drying step depends on properties and thickness of the printed ink, but the drying may be conducted to an extent such that the thickness of the ink does not change. For example, the drying step is carried out at a temperature of 60 to 100° C. When the ink is printed in a predetermined thickness on the curved surface, reflection phases of the incident lights entering the glass can be arranged. As a result, uneven color due to interference of reflected lights at the film interface does not occur and appearance quality is improved.

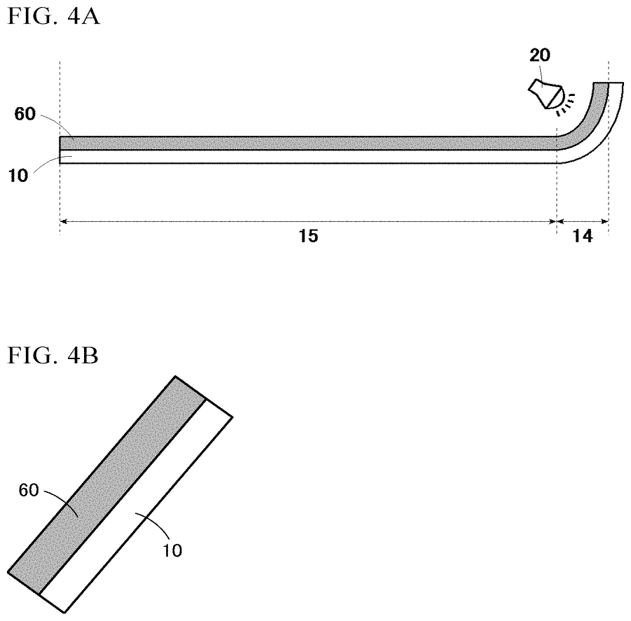

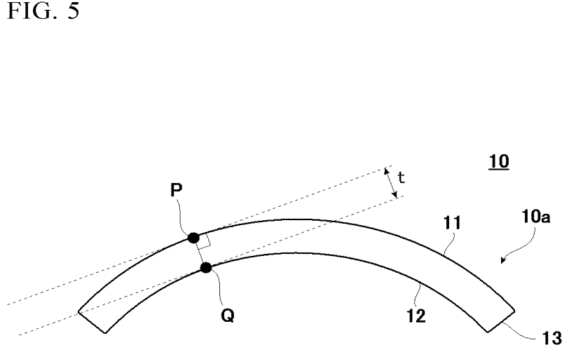

As shown in FIG. 4A, the inclined part drying step is conducted using, for example, a lamp heater 20. The inclined part drying step by the lamp heater 20 may be carried out by setting the curved surface area 14 of the cover glass 10 to the position of the lamp heater 20 and may be carried out by setting the lamp heater 20 to the position of the cover glass. The ink does not flow along an inclination direction by inserting the ink drying step as shown in FIG. 2B. Therefore, the thickness of the ink of the curved surface area is equal to the flat area or is in a range in which uneven color does not occur. The term “the thickness of the ink is equal” in the present invention means the case that the ratio of the thickness of the ink printed on the curved surface area to the thickness of the ink printed on the flat area is 0.8:1 to 1.2:1.

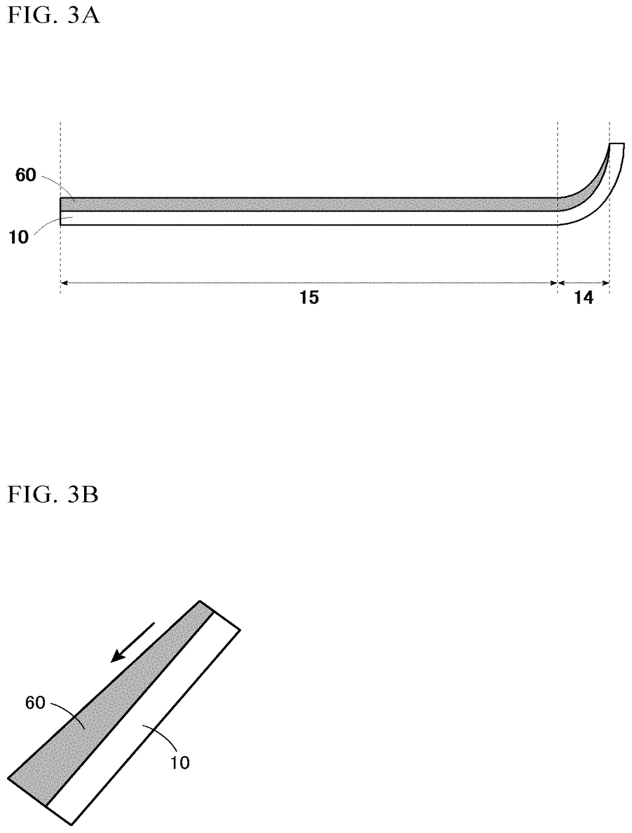

As shown in FIG. 3A, the thickness of an ink layer 60 printed on the curved surface area 14 differs from the thickness of the ink layer 60 printed on the flat area 15 in the conventional cover glass. The reason for this is that the thickness of the ink printed on the curved surface area 14 changes along the inclination of the curved surface until the printed ink cures. When the thickness of the ink 60 changes along the inclination as shown in FIG. 3B, the thickness of the ink layer is decreased as compared with the thickness of the glass layer and uneven color occurs.

As shown in FIG. 4A, the cover glass of this embodiment is that the ink layer 60 is formed on the curved surface area 14 and the flat area 15 in the same thickness or in the thickness range in which uneven color does not occur. The cover glass of this embodiment is that the curved surface area is dried before the thickness of the ink printed on the curved surface area changes along the inclination and as a result, the thickness of the ink printed on the curved surface does not change.

The end face 13 of the glass sheet-shaped body 10a constituting the cover glass of this embodiment is preferably that its thickness t is small, from the following reasons. When the thickness t is decreased, the mass of the cover glass is decreased. Absorbance in a thickness direction of the cover glass is proportional to the thickness t. Therefore, when the thickness t is decreased, the absorbance is decreased and the visible light transmittance in the thickness direction of the cover glass is increased. As a result, visibility is improved.

As shown in FIG. 5, in the present description, the thickness t of the glass sheet-shaped body 10a constituting the cover glass 10 is a shortest distance connecting an arbitrary point P on the first surface 11 to an intersection point Q between a normal line to the first surface 11 at the point P and the second surface 12 of the glass sheet-shaped body.

The cover glass 10 of this embodiment is that an average thickness tₐᵥₑ of the glass sheet-shaped body constituting the cover glass 10 is preferably 5 mm or less. The average thickness tₐᵥₑ of the glass sheet-shaped body constituting the cover glass 10 is preferably 2.3 mm or less, more preferably 2 mm or less and still more preferably 1.5 mm or less, from the standpoints of weight saving and sensing of a touch panel or the like. The lower limit of the average thickness tₐᵥₑ of the glass sheet-shaped body is preferably 0.5 mm or more, more preferably 0.7 mm or more and still more preferably 1.0 mm or more, for the same reasons as above.

The cover glass 10 of this embodiment is preferably that the variation of the thickness t in the curved surface area of the glass sheet-shaped body constituting the cover glass 10 is small. When the variation of the thickness t is small, the transmittance of the glass sheet-shaped body is uniform and visibility is improved. Specifically, a ratio tₘₐₓ/tₘᵢₙ between the maximum value Tₘₐₓ of the thickness and the minimum value tₘᵢₙ of the thickness, in the curved surface area of the glass sheet-shaped body is preferably 1.0 to 1.5 and more preferably 1.0 to 1.1.

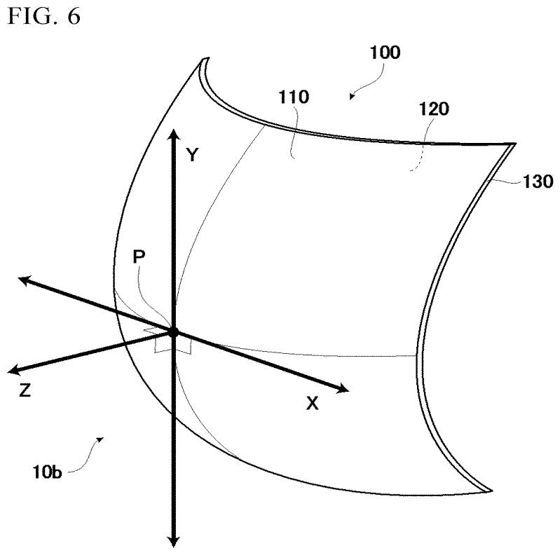

FIG. 6 is a view for explaining the curved surface area in one embodiment of the present invention and shows the cover glass being a multiply curved glass having a plurality of curved surface areas. A cover glass 100 shown in FIG. 6 includes a glass sheet-shaped body 10b having a first surface 110, a second surface 120 facing the first surface 110 and at least one end face 130 connecting the first surface 110 to the second surface 120. In this embodiment, in order to specify the curved surface area, axes of X, Y and Z are determined as below. Of the tangent direction of the first surface at an arbitrary point P on the first surface 110 of the glass sheet-shaped body constituting the cover glass 100, the tangent direction selected so as to satisfy the following requirements is defined as X axis; of the tangent direction of the first surface at the point P on the first surface, the direction orthogonal to X axis is defined as Y axis; and the direction orthogonal to X axis and Y axis is defined as Z axis. The X axis is, of the tangent direction of the first surface at the arbitrary point P on the first surface of the glass sheet-shaped body, the direction that a curvature radius R₁ (hereinafter referred to as first curvature radius) of a cross-section of the first surface of the glass sheet-shaped body on XZ plane passing X axis and Z axis is minimum. When multiple directions at which R₁ is minimum are present, at least one direction of those directions is defined as X axis and the first curvature radius R₁ may be determined.

The first surface of the glass sheet-shaped body 10b constituting the cover glass 100 has a curved surface area in which its surface bends in X axis direction in at least one point on the first surface. The curved surface area means an area in which the first curvature radius R₁ on XZ plane is 10000 mm or less at the arbitrary point P on the first surface. In FIG. 6, the entire first surface 110 constitutes the curved surface area.

In case where the cover glass has a curved surface area having the first curvature radius R₁ of 10000 mm or less, when the cover glass is used as a cover glass for interior parts for automobile, a display device and the like, the part arranged on those display surfaces appropriately bends. As a result, the viewing angle from users is small and visibility is improved. The first curvature radius R₁ of the curved surface area is preferably in a range of 300 to 3000 mm and more preferably in a range of 500 to 2000 mm, from the standpoint of improvement of visibility.

The curved surface area of the glass sheet-shaped body 10a constituting the cover glass 10 is that its surface may bend also in Y axis direction in at least one point on the curved surface area. In this case, the curvature radius R₂ (hereinafter referred to as a second curvature radius) of a cross-section of the first surface of the glass sheet-shaped body in YZ plane passing Y axis and Z axis is preferably 10000 mm or less, more preferably in a range of 300 to 3000 mm and still more preferably in a range of 500 to 2000 mm. As described before, of the tangent direction of the first surface at the arbitrary point P on the first surface of the glass sheet-shaped body, the direction in which the first curvature radius R₁ is minimum is X axis. Therefore, the first curvature radius R₁ and the second curvature radius R₂ satisfy the relationship of R₁/R₂.

(Processing and Forming)

The cover glass 10 is formed by cutting a large-sized sheet glass into a small-sized sheet glass, subjecting the sheet glass to each step of cutting and polishing, and then subjecting the sheet glass to a strengthening treatment such as chemical strengthening or physical strengthening. The cutting method of the sheet glass can be carried out using a scribe cleaving method, a laser cutting method or the like other than the cutting by diamond blade. When the strength of the cover glass 10 is desired to increase, a surface layer part of the cover glass 10 is preferably chemically strengthened. More preferably, the entire surface layer part is chemically strengthened. Tool performing cutting or polishing may use grindstone and further may use a buff including cloth, leather, rubber or the like, a brush or the like, other than the grindstone. In such a case, a polishing agent such as cerium oxide, alumina, carborundum, colloidal silica or the like may be used. Of those, grindstone is preferably used as a polishing tool from the standpoint of dimensional stability.

(Composition)

The cover glass 10 is constituted of a glass having high transparency. Multicomponent-based oxide glass may be used as a material of a glass used as the cover glass 10.

Specific examples of the composition of the glass used as the cover glass 10 are described below. However, the composition of the glass used as the cover glass 10 is not limited thereto. The glass used in this embodiment contains sodium, and glasses having various compositions can be used so long as the glass has the composition capable of being formed and being strengthened by a chemical strengthening treatment or a physical strengthening treatment. Specific examples of the glasses that can be used include aluminosilicate glass, soda-lime glass, borosilicate glass, lead glass, alkali barium glass, aluminoborosilicate glass, crystallized glass and alkali-containing optical glass.

The composition of the glass used as the cover glass 10 is not particularly limited, but examples of the composition include a composition containing, in mol % on an oxide basis: 50 to 80% of SiO₂, 2 to 25% of Al₂O₃, 0.1 to 20% of Li₂O, 0.1 to 18% of Na₂O, 0 to 10% of K₂O, 0 to 15% or MgO, 0 to 5% of CaO, 0 to 5% of P₂O₅, 0 to 5% of B₂O₃, 0 to 5% of Y₂O₃ and 0 to 5% of ZrO₂.

(Chemical Strengthening)

The chemically strengthened glass produced by the production method of this embodiment has a compressive stress layer formed by ion exchange on the glass surface. The ion exchange method exchanges ions in the surface of the glass and forms a surface layer in which compressive stress remains. Specifically, by performing ion exchange at a temperature of a glass transition point or lower, alkali metal ions (for example, Li ion and/or Na ion) having small ionic radius on the glass surface are substituted with other alkali metal ions (for example, Na ion and/or K ion) having larger ionic radius. Thus, compressive stress remains on the surface of the glass and strength of the glass is enhanced.

(Printing and Drying)

The printed layer is described below.

The “printed layer” in the present specification means a layer capable of imparting shielding property and beautiful appearance and is printed on the cover glass 10 as, for example, a light transmitting layer.

A method of forming the printed layer is preferably an infrared transmitting layer printing or a semi-transparent layer printing. The infrared transmitting layer printing is conducted by, for example, an inkjet printing method.

The inkjet printing method is a method of forming a pattern on a transparent sheet by discharging fine droplets of a liquid ink in a pulse shape from a nozzle. The position of the cover glass 10 is determined as the origin of a nozzle moving mechanism being the standard and the nozzle moves on the surface of the cover glass 10 in nearly horizontal direction while discharging fine droplets of the ink based on the command from a computer. Thus, dotted ink is continuously formed and a printed layer having a predetermined patter is formed. In the case of the cover glass in which the surface to be printed has a curved surface area, the distance between the nozzle discharging droplets of the ink and the cover glass 10 is preferably nearly constant, considering strain of a pattern and the like. For example, it is preferable that the distance between the nozzle and the cover glass 10 is maintained constant and then the mechanism rotating and moving the nozzle or cover glass according to the pattern is used. From the standpoints that supply pressure supplying the ink to the nozzle is stabilized and the amount of the ink discharged from the nozzle can be held constant, the mechanism fixing the nozzle, and rotating and moving the cover glass 10 to the nozzle is more preferred.

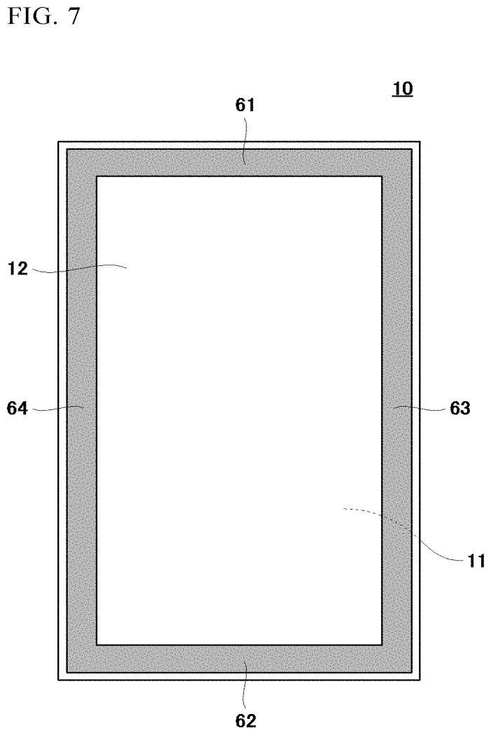

When the printed layer is a frame shape as shown in FIG. 7, it is preferable that the printed layer is divided into four linear patterns of an upper side printed layer 61, a lower side printed layer 62, a right side printed layer 63 and a left side printed layer 64 and each linear pattern is printed. When the pattern is formed while linearly moving the nozzle in one direction, the cover glass 10 is placed on a support (not shown) and a discharge hole of the nozzle is located at the lower right edge of the second surface 12 (printed surface) of the cover glass 10 in FIG. 7. Thereafter, the nozzle is moved to the lower left edge while discharging the ink from the discharge hole and the lower side printed layer 62 shown in FIG. 7 is printed. When the printed layer is printed on the curved surface area of the cover glass, the nozzle is moved along the curved surface.

Next, at least one of the support and the nozzle is relatively moved to locate the discharge hole on the upper right edge of the second surface. Thereafter, the nozzle is moved to the upper left edge while discharging the ink from the discharge hole and the upper side printed layer 61 as shown in FIG. 7 is printed.

Then, the discharge hole of the nozzle is located on the second surface (upper right edge of FIG. 7) of the cover glass. Thereafter, the nozzle is moved to the lower right edge while discharging the ink from the discharge hole and the right side printed layer 63 shown in FIG. 7 is printed.

Finally, at least one of the support and the nozzle is relatively moved to locate the discharge hole on the upper left edge of the second surface. Thereafter, the nozzle is moved to the lower left edge while discharging the ink from the discharge hole and the left side printed layer 64 shown in FIG. 7 is printed.

The thickness of the printed layer can be adjusted by controlling the amount of the ink discharged from the discharge hole and moving speed of the nozzle. When the thickness of the printed layer is increased, the amount of the ink discharged is increased and the moving speed is decreased. When the thickness of the printed layer is decreased, the amount of the ink discharged is decreased and the moving speed is increased.

After printing with the ink by the step of printing the infrared transmitting layer, the drying step of the ink is conducted within 10 seconds. When the drying step is conducted using the lamp heater 20, the lamp heater 20 is preferably arranged in a distance of about 50 mm to the printed layer. The lamp heater 20 is set to a temperature of a range that curing of the printed layer does not initiate, for example, 150° C. or lower. For example, when the drying step is conducted at 100° C. using a carbon fiber heater (CFH-290) manufactured by Inflidge Industrial Ltd., it is preferable that the output value is 100V and the irradiation time is 5 to 20 seconds. When the temperature is further high, the irradiation time is preferably 3 to 10 seconds.

After conducting the drying step, a light shielding layer is printed. For example, an inkjet printing method is used for printing the light shielding layer. When the glass has the curved surface area 14 as in this embodiment, at least one of the support and the nozzle is preferably moved along the curved surface area 14 of the glass.

The amount of the ink discharged can be controlled by the amount of droplets discharged from the discharge hole of the nozzle and an interval of the discharge (discharge pitch). When the amount of droplets from one discharge hole is represented by L (pL) and the discharge pitch is represented by P (μm), L/P (pL/μm) has a correlation with the discharge amount. The L/P is preferably 7 or less. When the L/P is the upper limit or less, the discharge amount is stabilized and when printing linearly, bleeding is suppressed and linearity is stabilized. Furthermore, when printing in curved line state, ink dripping can be suppressed and desired curved line shape is obtained. The L/P is more preferably 6 or less and still more preferably 4 or less.

The L/P is preferably 0.5 or more. When the L/P is the lower limit or more, a thickness and printing quality suitable for printing requiring light shielding property are obtained and satisfactory printed layer is obtained. The L/P is more preferably 0.6 or more and still more preferably 0.8 or more.

The relative moving speed between the nozzle and the cover glass is, for example, preferably 250 mm/sec or less. When the relative moving speed between the nozzle and the cover glass is larger than the upper limit, air flow and vibration generated between those are easy to have impact. For example, there is a possibility that contaminants involved by the air flow incorporate in the printed layer, causing defects. Furthermore, there is a possibility that desired shape precision is not obtained due to the vibration. For this reason, the relative moving speed is preferably equal to or smaller than the upper limit. The relative moving speed is more preferably 230 mm/sec or less and still more preferably 200 mm/sec or less.

The lower limit of the relative moving speed between the nozzle and the cover glass is not particularly limited, but is preferably 5 mm/sec or more. The relative moving speed affects the production time. When the relative moving speed is the lower limit or more, the cover glass 10 having high quality printed layer can be manufactured in high production efficiency. The relative moving speed is more preferably 10 mm/sec or more and still more preferably 20 mm/sec or more.

When printing the part forming a convex portion and a concave portion in the printed layer, preferably the printing pitch is narrowed as compared with the portion on which the convex portion and concave portion are not formed and simultaneously the amount of the ink discharged per one hole of the discharge head is decreased. By narrowing the printing pitch, fine patterns including the convex portion and concave portion can be drawn. By decreasing the amount of the ink discharged, the convex portion and concave portion can be prevented from being crushed by an excessive amount of the ink.

In this embodiment, the thicknesses of the upper side printed layer 61, the lower side printed layer 62, the right side printed layer 63 and the left side printed layer 64 are the same, and the printing conditions (the amount of the ink discharged and the moving speed of the nozzle) of those are preferably the same.

The distance between the nozzle and the cover glass is preferably controlled to 0.5 mm or more and 2 mm or less. The printed layer can be controlled to a desired range of a thickness and a homogeneous printed layer is obtained. The inks for printing the upper side printed layer 61, the lower side printed layer 62, the right side printed layer 63 and the left side printed layer 64 are preferably the same kind.

(Thermal Curing)

Thereafter, the cover glass is moved to a drying furnace to conduct thermal curing, whereby the printed layer is cured, and a cover glass with a printed layer is obtained. Drying and thermal curing of the upper side printed layer 61, the lower side printed layer 62, the right side printed layer 63 and the left side printed layer 64 may be conducted each time after forming every layer, or may be conducted after forming all of the layers.

(Effects)

The printed layer provided on the curved surface area of the cover glass is controlled to be equivalent to the flat area or to a range in which uneven color does not occur. Therefore, reflection phase of the incident light entering the glass can be arranged and as a result, uneven color at the interface of the printed layer is not observed with human eyes. Furthermore, color difference at the boundary between the cover glass and the printed layer is decreased and is unnoticeable. As a result, appearance quality is improved.

The present invention is not limited to only the above embodiments, and various modifications and design changes are possible within the scope not departing from the gist of the present invention. Specific procedures, structures and the like when carrying out the present invention may be other structures and the like within the scope capable of attaining the object of the present invention.

(Surface Structure)

When using an organic glass as the cover glass, a synthetic resin and the like as the cover glass, the cover glass may be constituted of laminated base materials regardless of same kinds or different kinds, and various adhesive layers may be inserted between the base materials.

When using an inorganic glass as the cover glass, any of a chemical strengthening treatment and a physical strengthening treatment may be applied thereto, but a chemical strengthening treatment is preferably applied. When the relatively thin inorganic glass as above is subjected to the strengthening treatment, a chemical strengthening treatment is preferred.

The ink forming the printed layer may be an inorganic ink and may be an organic ink. Examples of the inorganic ink include compositions including: at least one selected from SiO₂, ZnO, B₂O₃, Bi₂O₃, Li₂O, Na₂O and K₂O; at least one selected from CuO, Al₂O₃, ZrO₂, SnO₂ and CeO₂; Fe₂O₃; and TiO₂.

The organic ink can use various printing materials including a resin dissolved in a solvent. Examples of the resin that can be selected and used include at least one selected from the group consisting of an acryl resin, an urethane resin, an epoxy resin, a polyester resin, a polyamide resin, a vinyl acetate resin, a phenol resin, an olefin, an ethylene-vinyl acetate copolymer resin, a polyvinyl acetal resin, natural rubber, a styrene-butadiene copolymer, an acrylonitrile-butadiene copolymer, polyester polyol and polyether polyurethane polyol. Examples of the solvent that can be used include water, alcohols, esters, ketones, aromatic hydrocarbon solvents and aliphatic hydrocarbon solvents. Examples of the alcohols that can be used include isopropyl alcohol, methanol and ethanol. Examples of the esters that can be used include ethyl acetate. Examples of the ketones that can be used include methyl ethyl ketone. Examples of the aromatic hydrocarbon solvents that can be used include toluene, xylene, SOLVESSO™100 and SOLVESSO™150. Examples of the aliphatic hydrocarbon solvents that can be used include hexane. Those materials are merely examples, and other various printing materials can be used. The organic printing material is printed on the cover glass and the solvent is then evaporated, whereby a printed layer of a resin can be formed.

The ink used in the printed layer may contain a coloring agent. When the printed layer is colored black, black coloring agent such as carbon black can be used. Coloring agent having appropriate color can be used according to the desired color.

Desired number of the printed layers may be laminated, and the ink used for printing may be different in each layer. Furthermore, the printed layer may be printed on not only one main surface but on another main surface, and may be printed on an end face. When the desired number of printed layers is laminated, different ink may be used in each layer.

The ink used in the present invention is preferably a thermally-curable ink that can be cured by heating.

When the printed layer is formed using a thermally-curable resin material, a phenol resin, an epoxy resin, a melamine resin, an urea resin, an unsaturated polyester resin, a diallylphthalate resin, a polyurethane resin, a silicon resin and an acryl resin can be used.

When a liquid thermally-curable resin material is printed on the main surface of the cover glass, a method capable of printing in a uniform thickness over the entire surface of the range desired to be printed is preferred, and examples of the method include printing methods such as roller printing, curtain flow, die coating, gravure coating, microgravure coating, reverse coating, roll coating, flow coating and spray coating. However, printing by screen printing is extremely difficult.

The thickness of the printed film of the thermally-curable resin material is optional so long as it is a thickness sufficient to manufacture the desired cover glass 10. The thickness of the printed film is preferably 1.2 times or more and 3 times or less of the theoretically required film thickness. When the thickness of the printed film is 1.2 times or more of the theoretically required film thickness, the resin material can be completely charged in a mold regardless of influence of slight sheet thickness deviation and deflection, and dimensional accuracy and shape accuracy of the cover glass can be appropriately maintained. When the thickness of the printed film is 3 times or less of the theoretically required film thickness, the end face 13 of the cover glass 10 is prevented from being contaminated by the resin material extruded from an end part of a mold when pushing the mold to the cover glass 10. The theoretically required film thickness is represented by a ratio of the whole volume of the cover glass that is desired to be manufactured to the whole area of the cover glass that is desired to be manufactured.

The plane shape of the printed layer may be a linear shape along one side of the first surface 11, L-shape along continuous two sides and two straight line shape along facing two sides. When the first surface 11 is a polygon other than a square, a circle or a variant, the printed layer may be a frame shape corresponding to those shapes, a straight line shape along one side of a polygon and an arc shape along a part of a circle.

When the plane shape of the end part of the printed layer is a wave shape, the shape of wave may be a triangular wave and may be a rectangular wave. For any of those shapes, a region having high transmittance of visible light and a region having low transmittance thereof periodically appear at the end part corresponding to the wave shape, and then the boundary between the cover glass and the printed layer looks blurry to human eyes.

For this reason, the color difference at the boundary between the cover glass and the printed layer is naturally decreased and the color difference is not remarkable.

The cover glass of the present invention can be used in a cover member for display devices such as a cover glass of panel displays such as liquid crystal display or organic EL display, in-vehicle information instruments or mobile instruments. When the cover glass of the present invention is used in a cover for display devices, an object can be protected while securing visibility. Furthermore, color difference at the boundary between the cover glass and the printed layer in the cover member can be decreased and a display device having excellent beautiful appearance can be provided.

When the cover glass 10 is used in a display device, the printed layer preferably has a color corresponding to a color of the display device in non-display state. For example, in case where a color of the display device in non-display state is blackish, the printed layer is desirably blackish.

The printed layer cannot sometimes balance to a color required and physical properties. Even in this case, the color difference at the boundary between the cover glass and the printed layer is decreased by convex portions or concave portions. Therefore, the printed layer has no risk of the deterioration of beautiful appearance due to a color of the printed layer.

The printed layer of the cover glass 10 of the present invention may be a printed layer constituting a pattern of an article in which the cover glass 10 is used and improving design of the article.

In manufacturing the cover glass, the order of manufacturing is not particularly limited. For example, a structure including the cover glass 10 and an adhesive layer provided thereon is previously prepared, the structure is arranged on a frame, and a liquid crystal module is then attached thereto.

The cover glass may has a touch sensor and the like. When incorporating a touch sensor to the cover glass 10, the touch sensor is arranged on the first surface 11 side of the cover glass 10 through other adhesive layer not shown, and a liquid crystal module is then arranged thereon through an adhesive layer

### EXAMPLES

In Example 1, a glass base material containing, in mol % on an oxide basis, 64.2% of SiO₂, 8.0% of Al₂O₃, 12.5% of Na₂O, 4.0% of K₂O, 10.5% of MgO, 0.1% of CaO, 0.1% of SrO, 0.1% of BaO and 0.5% of ZrO₂ was prepared as an unstrengthened cover glass. The cover glass had a width of 20 mm, a length of 600 mm and a sheet thickness of 1.2 mm and was bent in a single direction in the vicinity of a length of 400 mm.

The cover glass was set to a position at three points, placed on a support and fixed to the support by suction with air. The support was fixed to a robot hand and the robot hand was fixed so as to connect to an arm manufactured by Mitsubishi Electric Corporation. The cover glass can be moved to an appropriate position in each step by driving the arm. The arm used had 6-shaft structure, but may have any structure so long as the cover glass can be maintained at a constant position and can be moved.

The cover glass fixed to the support was transferred to the printing step of infrared transmitting ink.

The infrared transmitting ink used was an ink having an infrared transmitting ink solid content of 19 mass % and a viscosity CP of 5.7. The infrared transmitting ink was introduced in a tank and circulated including the inside of an inkjet head, and the pressure in the circulation system was controlled such that the ink did not drop from the head. While the portion of the cover glass to be coated with the infrared transmitting ink was moved so as to face the inkjet head, the ink was discharged such that the film thickness in liquid state is set to 15 μm, thereby conducting the printing.

After printing a curved surface area, the printed layer was promptly moved just under a heater and the ink was dried using a lamp heater. When drying a flat surface, the cover glass was moved in a horizontal direction to the lamp heater, whereby the drying proceeded uniformly. Carbon fiber heater (CFH-290) manufactured by Inflidge Industrial Ltd. was used in the drying step. Output value was 100V and irradiation time was 10 sec in each of the flat area and the curved surface area.

After the drying step, the cover glass was removed from the robot hand and moved onto a mesh-shape drying rack. The cover glass with the drying rack was placed in a drying furnace and heated at 230° C. to cure the resin. The heating time was 60 minutes and the film thickness after curing was 2.8 μm in the measured value. After heating and curing, the drying rack was taken out from the drying furnace and cooled to room temperature.

After completion of the drying, the cover glass was transferred to a printing step of black ink.

The black ink used had a black ink solid content of 25 mass % and a viscosity CP of 9.5. The black ink was introduced into a tank and was printed under the same conditions as in the infrared transmitting ink except that a film thickness in liquid state was 20 μm.

The same carbon fiber heater (CFH-290) manufactured by Inflidge Industrial Ltd. as in the drying step of the infrared transmitting ink was used in the drying step. When drying, the cover glass was moved in a horizontal direction, whereby the printing proceeded uniformly. The output value was 100V and the irradiation time was 10 sec in each of the flat area and the curved surface area.

After the drying step, the cover glass was removed from the robot hand and moved onto a mesh-shape drying rack. The cover glass with the drying rack was placed in a drying furnace and heated at 230° C. to cure the resin. The heating time was 60 minutes and the film thickness after curing was 5.0 μm in the measured value. After heating and curing, the drying rack was taken out from the drying furnace and cooled to room temperature.

In Comparative Example 1, the cover glass having the same composition as in the cover glass used in Example 1 was prepared, but differing from Example 1, the drying step was not conducted and the infrared transmitting ink and the black ink were printed and cured by heating.

Various evaluations in Example and Comparative Example were conducted by the following analytical methods.

Specifically, under the illumination of illuminance 1000 lux, a distance between a glass and eyes of a judge was set to 50 cm, samples prepared in Example and Comparative Example were placed just under the light source and visually examined at an angle of 45°. When uneven color was not observed on the surface of the glass, the glass was judged as “A” and when uneven color was observed, the glass was judged as “B”.

Table 1 below shows as to whether operation of each steps in Example and Comparative Example were conducted or not. The evaluation results obtained in Example and Comparative Example are shown in table 2 below.

TABLE 1

| Procedures | | Comparative | |
|---|---|---|---|
| of step | Step | Example 1 | Example 1 |
| 1 | Printing of infrared transmitting | Conducted | Conducted |
| | layer | | |
| 2 | Drying of inclined part | None | Conducted |
| 3 | Curing in drying furnace | Conducted | Conducted |
| 4 | Printing of black layer | Conducted | Conducted |
| 5 | Drying of inclined part | None | Conducted |
| 6 | Curing in drying furnace | Conducted | Conducted |

TABLE 2

| | Comparative | |
|---|---|---|
| | Example 1 | Example 1 |
| Improvement of uneven color | B | A |

As shown in table 2, in Example 1, when the infrared transmitting ink or the black ink was printed on the cover glass and the drying treatment of the inclined part was then conducted, uneven color did not occur and appearance quality was improved.

The first printed layer was formed using a thermally-curable ink in Example 1, but the second printed layer and the subsequent printed layers can be formed by using other appropriate inks, for example, a photosetting ink, in place of the thermally-curable ink.

The cover glass was used in Comparative Example and Example, but the glass is not required to be limited to specific uses and it is apparent for one skilled in the art that the present invention is applicable to any case of printing a glass.

### REFERENCE SIGNS LIST

10, 100 Cover glass
11, 110 First surface
12, 120 Second surface
13, 130 End face
10a, 10b Glass sheet-shaped body
14 Curved surface area
15 Flat area
20 Lamp heater
60 Printed layer
61 Upper side printed layer
62 Lower side printed layer
63 Right side printed layer
64 Left side printed layer

What is claimed is:

1. A method of forming a printed layer on a glass comprising a curved surface area, the method comprising:
a printing step of printing with a thermally-curable first ink on the curved surface area to form a first printed layer; and
a drying step of drying the first printed layer.

2. The method of forming a printed layer according to claim 1, further comprising a curing step of thermally curing the first printed layer after the drying step.

3. The method of forming a printed layer according to claim 1, further comprising a printing step of printing with a second ink on the first printed layer to form a second printed layer.

4. The method of forming a printed layer according to claim 3, wherein the first printed layer is an infrared transmitting layer, and the second printed layer is a light shielding layer.

5. The method of forming a printed layer according to claim 3, wherein the second ink is a thermally-curable ink.

6. The method of forming a printed layer according to claim 1, wherein the first ink is an ink having a light transmitting property.

7. The method of forming a printed layer according to claim 1, wherein the first ink is an ink having an infrared transmitting property.

8. The method of forming a printed layer according to claim 3, wherein the second ink is an ink having a light shielding property.

9. The method of forming a printed layer according to claim 1, wherein the drying step is conducted by a lamp heater.

10. The method of forming a printed layer according to claim 2, wherein the curing step is conducted in a drying furnace.

11. The method of forming a printed layer according to claim 1, wherein the glass is a cover glass.

12. A glass comprising a curved surface area that comprises a printed layer formed thereon with a thermally-curable first ink, wherein:
the printed layer is formed on the curved surface area;
the printed layer comprises a first printed layer and a second printed layer;
the first printed layer and the second printed layer have different visible light transmittances from each other;
the first printed layer has the visible light transmittance higher than the visible light transmittance of the second printed layer; and
the first printed layer has a film thickness being constant in the curved surface area or being in a range in which an uneven color does not occur in the curved surface area.

13. The glass according to claim 12, wherein the first printed layer is an infrared transmitting layer, and the second printed layer is a light shielding layer.

14. The glass according to claim 12, wherein the first printed layer has the visible light transmittance of 1% or less.

15. The glass according to claim 12, wherein the second printed layer has the visible light transmittance of 0.01% or less.

16. The glass according to claim 12, wherein the glass is a chemically strengthened glass.

17. The glass according to claim 12, wherein the glass is a multiply curved glass.

18. The glass according to claim 12, wherein the glass is a cover glass.
